(19) United States
(12) Patent Application Publication
(10) Pub. No.: US 2009/0321969 A1
(43) Pub. Date: Dec. 31, 2009

(54) OPTICAL ELEMENT MOLDING METHOD

(76) Inventor: Masanori UTSUGI, Saitama-shi (JP)

Correspondence Address: BIRCH STEWART KOLASCH & BIRCH, PO BOX 747, FALLS CHURCH, VA, 22040-0747, US

(21) Appl. No.: 12/483,847

(22) Filed: Jun. 12, 2009

(30) Foreign Application Priority Data
Jun. 27, 2008 (JP) P2008-168065

(51) Int. Cl. B29D 11/00

(52) U.S. Cl. 264/1.7

(57) ABSTRACT

An optical element molding method provides to mold an optical element without a defective configuration such as a groove on the outer surface when one optical element is molded by placing different molding materials one on another.

The optical element molding method includes pressing a first molding material having a first viscosity and a second molding material having a second viscosity different from the first viscosity, between molds of a forming mold including a pair of upper mold and lower mold for molding an optical element.

### CROSS-REFERENCE TO RELATED APPLICATIONS

This application is based on and claims priority under 35 USC 119 from Japanese Patent Application No. 2008-168065 filed Jun. 27, 2008; the entire contents of which are incorporated herein by reference.

### BACKGROUND

1. Technical Field

The present invention relates to an optical element molding method, and to an optical element molding method suitable for the application to optical glass materials.

2. Related Art

Examples of methods of forming optical elements such as optical lenses and prisms include a method using a forming mold that includes an upper mold and a lower mold provided with a transfer surface having an optical function transfer surface and a body mold that defines the positions, in the horizontal direction, of the upper and lower molds. According to this method, an optical element is molded by pressing the forming mold while heating a molding material (optical glass material) such as a preform.

Normally, one preform is placed on the lower mold, the upper mold is placed on the preform, and the preform is heated to be softened. Then, the preform is pressed between the upper and lower molds, whereby one optical element is molded finally. On the other hand, for example, there is a case where, to mold one optical element, two or more preforms are placed one on another and pressed to be molded like the technology disclosed in Patent Reference 1 (JP-A-2004-010456). In this case, the optical element is molded not by one operation but by two or more operations. Consequently, an optical element can be molded that has a volume too large to be accommodated in the forming mold with one preform. In addition, a problem can be prevented in that compressed air is embedded in the molded optical element because of the difference between the shape of the preform and that of the forming mold.

In the Patent Reference 1, first, one preform (optical glass material) is pressed to mold one end part, and the upper mold is removed. Then, another preform is placed on the molded one end part, heated to be softened, and pressed to be molded. Consequently, an optical element formed of the two preforms integrated with each other can be molded.

However, if the two preforms are simultaneously heated in the case where they are molded into one piece, one preform enters into the other preform. For example, FIG. 5A shows an example in which it is intended to mold an optical element by placing a spherical preform 80 and a cylindrical preform 82 one on the other. FIG. 5A is a cross-sectional view showing a failure example 90 obtained as a result of intending to mold an optical element by the example described above. As shown in FIG. 5A, one preform 80 enters into the other preform 82 to form a groove M on the outer surface. Consequently, the outer surfaces of the preform 80 and the preform 82 are not smoothly connected, so that a desired configuration as an optical element cannot be obtained.

### SUMMARY

Accordingly, the present invention is made in view of the above-mentioned problem, and one object of the present invention is to provide a new and improved optical element molding method capable of molding an optical element without any defective configuration such as a groove being left on the outer surface when different molding materials are placed one on another to form one optical element.

According to an aspect of the present invention, An optical element molding method for molding an optical element by a forming mold including a pair of upper mold and lower mold, the optical element molding method comprising; pressing a first molding material having a first viscosity and a second molding material having a second viscosity different from the first viscosity, between the pair of upper mold and lower mold.

The optical element molding method may include prior to the pressing step: placing the first molding material on the lower mold; heating the lower mold and the first molding material; placing the second molding material in a condition where the viscosity of the second molding material is higher than the viscosity of the first molding material, on the first molding material; and placing the upper mold on the second molding material. And at the pressing step, the first molding material and the second molding material may be pressed by the upper mold and the lower mold in a condition where the viscosity of the second molding material is higher than the viscosity of the first molding material.

At the pressing step, the second molding material may have a viscosity of not less than 10⁹ Pa·s.

At the pressing step, the second molding material may have a temperature less than a deformation point.

At the pressing step, the first molding material may have a temperature not less than a glass transition point.

The raw materials of the first molding material and the second molding material may be the same.

The optical element molding method may include, after the pressing step, heating the first molding material and the second molding material to a temperature not less than the glass transition point.

Alternatively, the optical element molding method may include, after the pressing step, heating the first molding material and the second molding material to a temperature at which the first and second materials have a viscosity of not more than 10¹¹ Pa·s.

The optical element molding method may include, after the heating the first molding material and the second molding material, cooling the first molding material and the second molding material; and taking out an optical element formed of the first molding material and the second molding material.

The first molding material may be a spherical glass preform, and the second molding material may be a cylindrical glass preform.

At heating the first molding material and the second molding material, the first molding material and the second molding material may be pressed so that outer surfaces of the first molding material and the second molding material are smoothly connected.

According to the present invention, when one optical element is molded by placing different molding materials one on another, an optical element can be molded without any defective configuration such as a groove left on the surface.

### BRIEF DESCRIPTION OF THE DRAWINGS

FIG. 1 is a cross-sectional view showing an optical element molding apparatus according to an embodiment of the present invention;

FIG. 2 is a flowchart showing an optical element molding method according to the embodiment;

FIG. 3 is a graph showing changes, with respect to time, of the temperatures of preforms to be molded;

FIGS. 4A to 4J are cross-sectional views showing a forming mold and the preforms according to the embodiment, and also show the flow of the molding process;

FIG. 5A is a cross-sectional view showing the failure example obtained as a result of molding by the conventional example; and

FIG. 5B is a cross-sectional view showing an optical element molded by a molding method of the embodiment.

### DETAILED DESCRIPTION

Hereinafter, a preferred embodiment of the present invention will be described in detail with reference to the attached drawings. In the description and the drawings, elements having substantially the same functional structures are denoted by the same reference numerals, whereby overlapping descriptions are omitted.

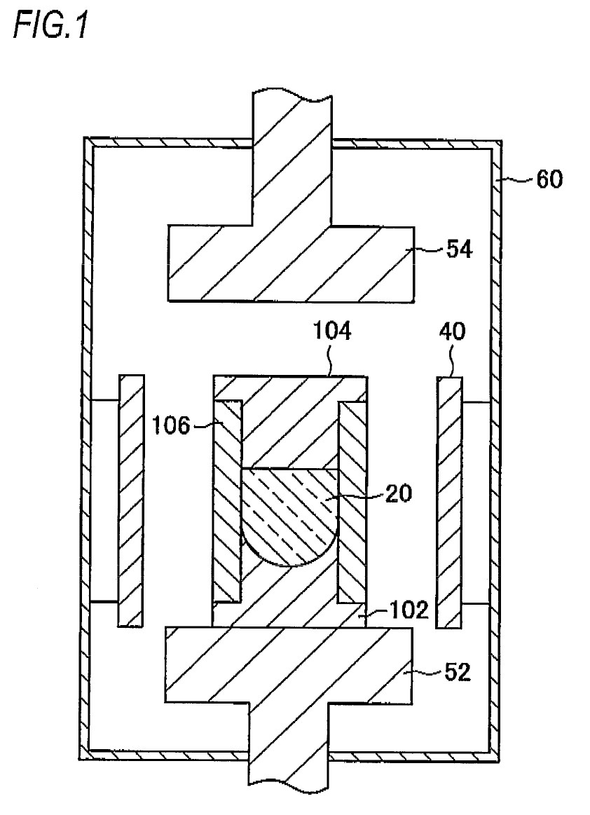

First, the structure of an optical element molding apparatus according to the embodiment of the present invention will be described FIG. 1 is a cross-sectional view showing the optical element molding apparatus according to the present embodiment.

The optical element molding apparatus includes, for example, a lower mold unit 52, an upper mold unit 54, a heater 40 and a chamber 60.

On the lower mold unit 52, a lower mold 102, an upper mold 104 and a body mold 106 (hereinafter, collectively called forming mold) can be placed. By the lower mold unit 52 or the upper mold unit 54 being driven upward or downward, the lower mold unit 52 makes contact with the lower mold 102, and the upper mold unit 54 makes contact with the upper mold 104. Further, the lower mold unit 52 and the upper mold unit 54 press the lower mold 102 and the upper mold 104. The lower mold unit 52 or the upper mold unit 54 is driven in a direction opposite to the direction in which the lower mold 102 and the upper mold 104 are pressed, thereby releasing the pressing of the lower mold 102 and the upper mold 104.

The heater 40 which is an example of a heating portion is placed around the body mold 106, and heats the forming mold and the preform. The heater 40 is capable of heating the preform so that its temperature is equal to or more than a deformation point At(Ts). While an example in which the heater 40 is placed around the body mold 106 is shown in the present embodiment, the present invention is not limited to such an example. For example, the heating portion may be incorporated in the lower mold unit 52 or the upper mold unit 54.

The chamber 60 accommodates the lower mold unit 52, the upper mold unit 54 and the heater 40. The chamber 60, for example, can be filled with an inert gas and can be evacuated. Since the space where the forming mold is placed is definite because of the chamber 60, the inside can be efficiently heated and cooled.

Next, referring to FIG. 1, the forming mold will be described. The forming mold includes a pair of upper mold 104 and lower mold 102 and the body mold 106.

The upper mold 104 and the lower mold 102 each have a body part which is, for example, cylindrical. On one ends thereof, a transfer surface including an optical function transfer surface is formed, and on the other surfaces thereof, a flange surface larger than the diameter of the body part is formed. The upper mold 104 and the lower mold 102 are disposed so that the transfer surfaces of the upper mold 104 and the lower mold 102 are opposed to each other. The flange surfaces of the upper mold 104 and the lower mold 102 are disposed so as to be in contact with the upper mold unit 54 and the lower mold unit 52. In the present embodiment, the lower mold 102 has an aspherical transfer surface, and the upper mold 104 has a plane transfer surface.

The body mold 106 has, for example, a hollow cylindrical shapes The inner surface of the body mold 106 is in contact with the outer surface of the upper mold 104 so as to be slidable. The body mold 106 is capable of guiding the vertical movement of the upper mold 104. The body mold 106 defines the positions, in the horizontal direction, of the upper mold 104 and the lower mold 102. The inner surface of the body mold 106 is in contact with the outer surface of the lower mold 102. The body mold 106 is fitted on the lower mold 102.

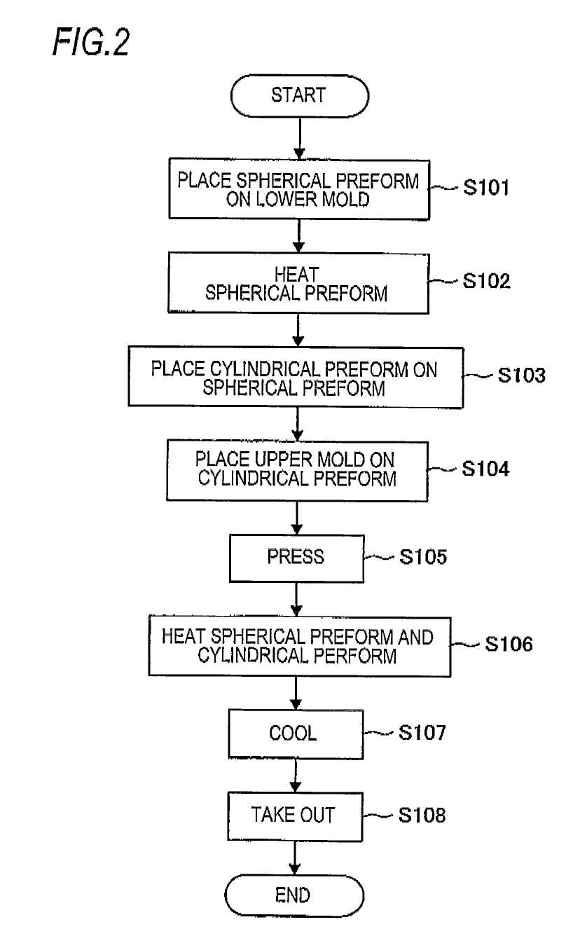

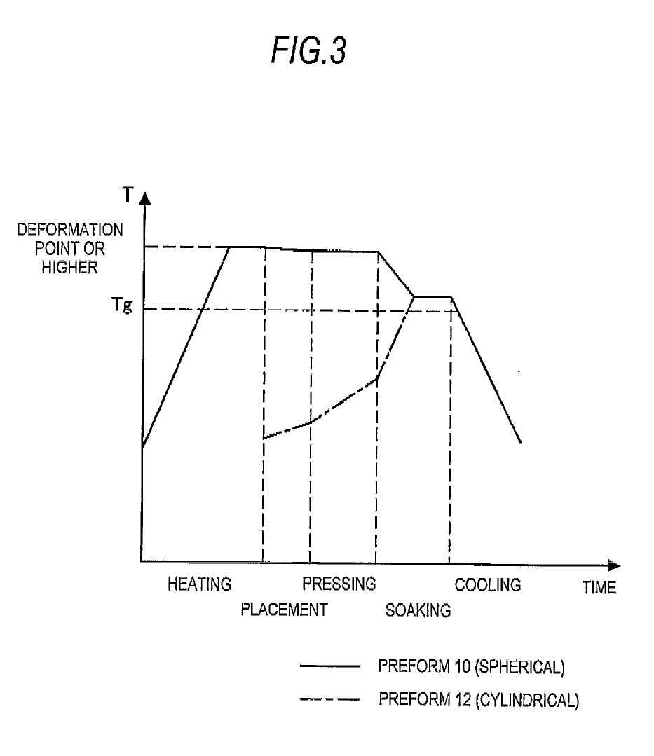

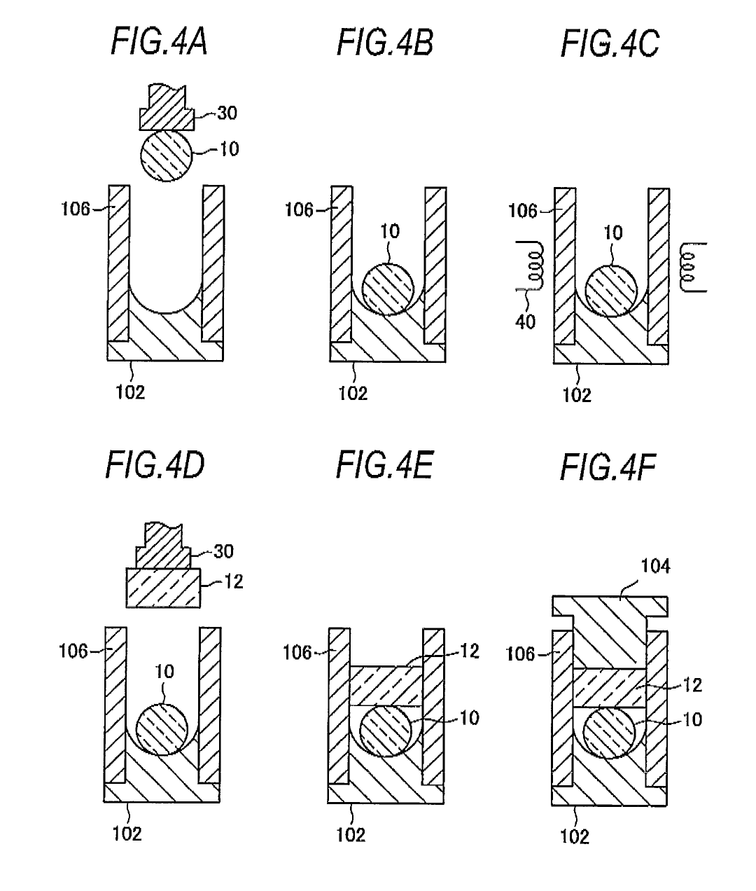

Next, an optical element molding method according to the present embodiment will be described. FIG. 2 is a flowchart showing the optical element molding method according to the present embodiment. FIG. 3 is a graph showing changes, with respect to time, of the temperatures of the preforms to be molded. FIGS. 4A to 4J are cross-sectional views showing the forming mold and the preforms according to the present embodiment, and also show the flow of the molding process.

First, as shown in FIG. 4A, a preform 10 (spherical preform, the first molding material) is conveyed to the forming mold by a conveyer 30. At this time, the forming mold may be placed on the lower mold unit 52 or may be conveyed to the lower mold unit 52 and placed thereon after the preform 10 is placed on the lower mold 102. The preform 10 is an optical glass material that, after molding, constitutes one end of an optical element 20 as a molding. The preform 10 has, for example, a spherical shape.

Then, as shown in FIG. 4B, the preform 10 is placed on the lower mold 102 by the conveyer 30 (step S101). Then, the preform 10 is heated by the heater 40 (step S102). At this time, the preform 10 is heated at least to the glass transition point Tg or higher, for example, equal to or more than the deformation point At(Ts) of the optical glass material (for example, the deformation point At(Ts)+10 to 40° C.). At the deformation point At (Ts), the temperature of the optical glass material is one at which the optical glass material can be deformed by pressurization, and the viscosity of the optical glass material is, for example, approximately 10¹⁰ to 10¹¹p (poises) (=10⁹ to 10¹⁰ Pa·s). Consequently, there are cases where the preform 10 is slightly deformed into a configuration of a sphere slightly losing its shape as shown in FIG. 4C. The change in the temperature of the preform 10 is shown by the solid line in FIG. 3. While the temperature of the preform 10 is constant when it is equal to or more than the deformation point At(Ts) in FIG. 3, the present invention is not limited to the case where the temperature is constant.

Next, as shown in FIG. 4D, a preform 12 (cylindrical preform, the second molding material) is conveyed to the forming mold by the conveyer 30. The preform 12 is an optical glass material that, after molding, is joined to the preform 10 and constitutes the other end of the optical element 20 as a molding. The preform 12 has, for example, a cylindrical shape.

Then, as shown in FIG. 4E, the preform 12 is placed on the preform 10 by the conveyer 30 (step S103). At this time, the preform 12 is placed in a state of not being heated and softened. On the other hand, the preform 10 is in a state of not being softened by heating. Then, as shown in FIG. 4F, the upper mold 104 is placed on the preform 12 (step S104). The preform 12 may be placed in the chamber 60 filled with an inert gas (nitrogen gas, etc.) of a pressure higher than the outside pressure, before it is placed on the preform 10 by the conveyer 30. By doing this, when the preform 12 is placed, it is unnecessary to open or close the chamber 60, so that the forming mold and the like in the high temperature state can be prevented from oxidizing.

Then, as shown in FIG. 4G, the preforms 10 and 12 are pressed by the upper mold 104 and the lower mold 102 (step S105). At this time, the preform 12 is placed in the state of not being heated or softened as mentioned above, and pressed as it is. Therefore, the preform 12 never reaches the deformation point At(Ts) or higher even though it makes contact with the forming mold held at a constant temperature when its temperature is equal to or more than the deformation point At(Ts). In order that the preform 12 is not softened, it is preferable that the temperature of the upper mold 104 be set at a temperature equal to or less than the glass transition point Tg until the pressing step is finished.

On the other hand, the preform 10 is once heated to the molding temperature equal to or more than the deformation point At(Ts) in the previous step. For this reason, even though the preform 10 makes contact with the preform 12, the temperature of the preform 10 does not decline rapidly, and is at least equal to or more than the softening point of the optical glass material, preferably, a molding temperature equal to or more than the deformation point At(Ts). To maintain the temperature of the preform 10, the lower mold 102 is held at the molding temperature. Consequently, in this pressing step, the preform 10 largely deforms and the preform 12 hardly deforms. The deformation point At(Ts) is a temperature at which a horizontally placed glass rod starts to rapidly bend because of its own weight, and the viscosity of the optical glass material is, for example, not less than 10¹⁰ to 10¹¹p (poises) (=10⁹ to 10¹⁰ Pa·s). Since the temperature of the preform 10 is one that makes the preform 10 easily deform, the preform 10 deforms according to the shapes of the lower mold 102, the body mold 106 and the preform 12 by pressing.

Consequently, the preform 10 never enters into the preform 12, so that the preform 12 never deforms inward by the preform 10 entering thereinto. Therefore, the joint, on the outer surface, between the preform 10 and the preform 12 has a shape such that the shape of the forming mold is smoothly transferred.

Next, as shown in FIG. 4H, the preforms 10 and 12 are heated by the heater 40 to undergo soaking (step S106). At this time, the preforms 10 and 12 are soaked at near the glass transition point Tg of the optical glass material. When the preforms 10 and 12 are soaked at near the glass transition point Tg, the viscosity of the optical glass material is, for example, approximately 10¹²P (poises) (=10¹¹ Pa·s). By the temperature being near the glass transition point Tg, the residual distortion in the glass can be eliminated. The preforms 10 and 12 may be heated so that the viscosity is, for example, 10⁷−10¹²P(poises) (=10⁶ to 10¹¹ Pa·s). By heating the preforms 10 and 12 so that their temperatures become the same, separation (coming off) due to the shrinkage difference therebetween can be prevented.

The change in the temperature of the preform 12 is shown by the alternate long and short dashed line in FIG. 3. At the time of pressing at step S105, as mentioned above, the temperature of the preform 12 is less than the deformation point At(Ts) of the optical glass material, and becomes the same as that of the preform 10 by the soaking processing at step S106. While the temperature of the preform 12 is constant near the glass transition point Tg in FIG. 3, the present invention is not limited to the case where it is constant.

Next, as shown in FIG. 3, the preforms 10 and 12 are cooled (step S107). In the cooling step, the preforms 10 and 12 are, first, cooled slowly, and then, cooled rapidly. Then, as shown in FIG. 4I, the upper mold 104 of the forming mold is removed. After the cooling, the preforms 10 and 12 are molded as the optical element 20. Then, as shown in FIG. 4J, the optical element 20 is taken out from the forming mold (step S108).

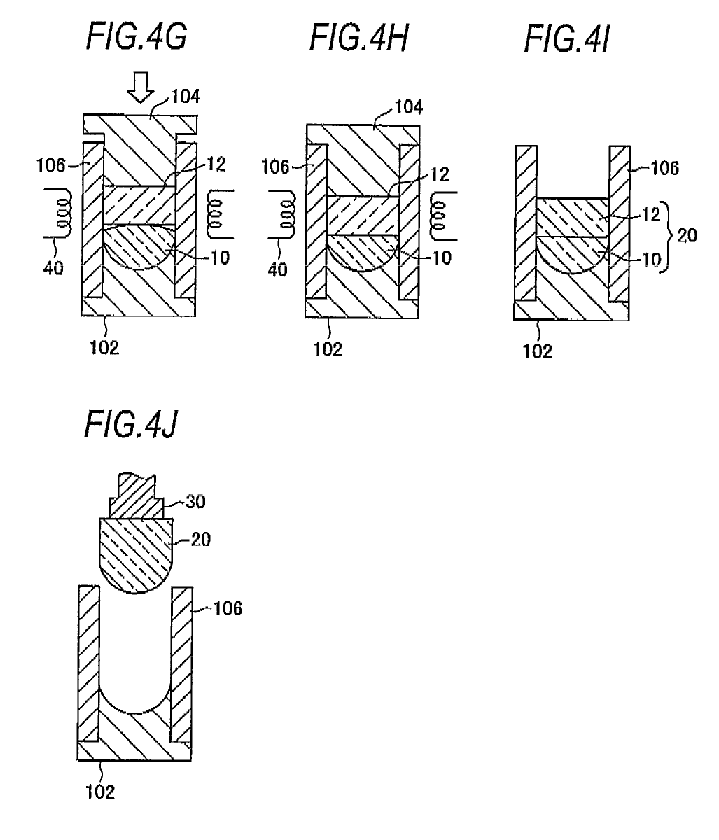

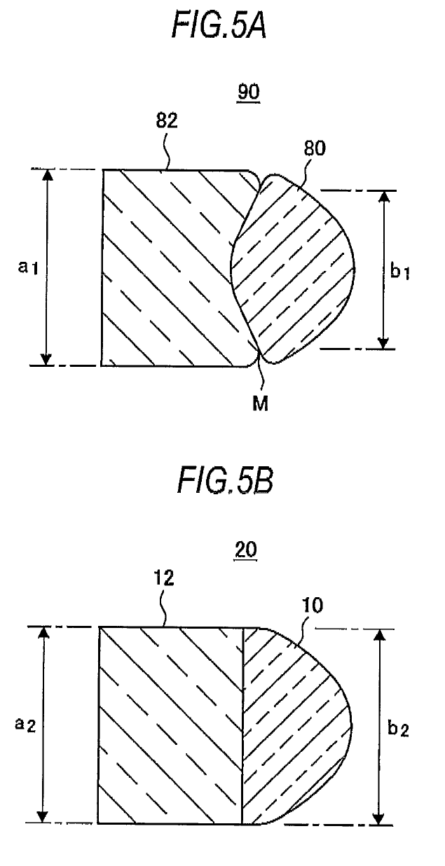

As described above, according to the related method, since two preforms are heated at the same time, one preform enters into the other preform. For example, as shown in FIG. 5A, one preform 80 enters into the other preform 82, so that the groove M is formed on the periphery as in the failure example 90. Consequently, the outer surfaces of the preforms 80 and 82 are not smoothly connected, so that a desired shape as an optical element cannot be obtained. For example, the diameter a1 of the side of the preform 82 differs from the diameter b1 of the area of connection between the preforms 80 and 82. Consequently, the failure example 90 of FIG. 5A obtained by the related method does not perform the optical function as a lens or the like.

On the contrary, according to the present embodiment, the optical element 20 as shown in FIG. 5B can be molded. FIG. 5B is a cross-sectional view showing the optical element 20 molded by the molding method of the present embodiment. The preform 10 never enters into the preform 12, so that the preform 12 never deforms inward by the preform 10 entering thereinto. Consequently, the outer surface of the optical element 20 is smooth, and the diameter a2 of the side of the preform 12 and the diameter b2 of the area of connection between the preform 10 and the preform 12 are the same. Consequently, the optical element 20 has a desired shape, and performs the optical function as a lens or the like.

Moreover, to prevent the above-mentioned problem in that one preform enters into the other preform, it can be considered to use preforms having different glass transition points Tg. By doing this, the preforms can be joined together with one of the preforms being hard, and there is a possibility that it is prevented that one preform enters into the other preform. However, since preforms having different glass transition points have different expansion coefficients, the molded optical element has a structure easy to separate (come off) into the original preforms.

On the contrary, according to the present embodiment, since two preforms of the same raw material are joined together, the problem of separation (coming off) never occurs as long as the soaking processing is performed. In addition, since the preforms of the same raw material are joined together, it is unnecessary to consider the refraction at the joint surface, so that the optical design is easy.

While the preferred embodiment of the present invention is described above in detail with reference to the attached drawings, the present invention is not limited to such an example. It is obvious that one of ordinary skill in the art to which the present invention pertains can easily arrive at various variations and modifications within the scope of the technical idea described in claims, and it is to be understood that these also belong to the technical scope of the present invention.

For example, while an example of the optical element molding apparatus that heats, presses and cools the forming mold by a pair of lower mold unit 52 and upper mold unit 54 is shown in the above-described embodiment, the present invention is not limited to such an example. For example, it may be a continuous optical element molding apparatus provided with a different lower mold unit 52 and upper mold unit 54 for each of the heating step, the pressing step and the cooling step. The continuous optical element molding apparatus includes a plurality of pairs of lower mold unit 52 and upper mold unit 54. For example, when the heating step at the lower mold unit 52 and the upper mold unit 54 for the heating step is finished, the forming mold moves to the adjacent lower mold unit 52 and upper mold unit 54 for the pressing step. Then, the forming mold is pressed by the lower mold unit 52 and upper mold unit 54 for the pressing step. Then, when the pressing step is finished, the forming mold moves to the adjacent lower mold unit 52 and upper mold unit 54 for the cooling step. By the forming mold thus moving successively, an optical element is molded.

The molding apparatus of the present embodiment may have a structure in which, for example, the upper mold 104 is always fixed to the upper mold unit 54. Further, while the upper mold unit 54 can be driven upward or downward and the lower mold unit 52 is fixed in the above-described embodiment, a structure may be adopted in which the upper mold unit 54 is fixed and the lower mold unit 52 can be driven upward or downward.

While an example in which the molded optical element 20 has an aspherical optical function surface on one end and has a plane surface on the other end is described in the above embodiment, the present invention is not limited to such an example. For example, one or both of the end surfaces of the optical element may be concave surfaces or may be convex surfaces. Moreover, while an example in which two preforms are placed one on another is described in the above embodiment, the present invention is not limited to such an example. For example, the present invention is applicable to cases where three or more preforms are joined together.

What is claimed is:

1. An optical element molding method for molding an optical element by a forming mold including a pair of upper mold and lower mold, the optical element molding method comprising:
pressing a first molding material having a first viscosity and a second molding material having a second viscosity different from the first viscosity, between the pair of upper mold and lower mold.

2. The optical element molding method according to claim 1, further comprising prior to the pressing step:
placing the first molding material on the lower mold;
heating the lower mold and the first molding material;
placing the second molding material in a condition where a viscosity of the second molding material is higher than a viscosity of the first molding material, on the first molding material; and
placing the upper mold on the second molding material,
wherein, at the pressing step, the first molding material and the second molding material are pressed by the upper mold and the lower mold in the condition where the viscosity of the second molding material is higher than the viscosity of the first molding material.

3. The optical element molding method according to claim 1, wherein at the pressing step, the second molding material has a viscosity of not less than 10⁹ Pa·s.

4. The optical element molding method according to claim 1, wherein at the pressing step, the second molding material has a temperature less than a deformation point.

5. The optical element molding method according to claim 1, wherein at the pressing step, the first molding material has a temperature not less than a glass transition point.

6. The optical element molding method according to claim 1, wherein raw materials of the first molding material and the second molding material are the same.

7. The optical element molding method according to claim 1, further comprising, after the pressing step, heating the first molding material and the second molding material to a temperature not less than the glass transition point.

8. The optical element molding method according to claim 1, further comprising, after the pressing step, heating the first molding material and the second molding material to a temperature at which the first and second materials have a viscosity of not more than 10¹¹ Pa·s.

9. The optical element molding method according to claim 7, comprising after the heating the first molding material and the second molding material:
cooling the first molding material and the second molding material; and
taking out an optical element formed of the first molding material and the second molding material.

10. The optical element molding method according to claim 1, wherein the first molding material is a spherical glass preform and the second molding material is a cylindrical glass preform.

11. The optical element molding method according to claim 1, wherein the first molding material and the second molding material are pressed so that outer surfaces of the first molding material and the second molding material are smoothly connected.
